(19) United States
(12) Patent Application Publication
(10) Pub. No.: US 2024/0194085 A1
(43) Pub. Date: Jun. 13, 2024

(54) Methods and Systems For Automated Interactive Quran Education

(71) Applicant: Halid Ziya Yerebakan, Carmel, IN (US)

(72) Inventors: Halid Ziya Yerebakan, Carmel, IN (US); Sezai SABLAK, East Stroudsburg, PA (US); Mustafa S Yildirim, Istanbul (TR); Bilal Sert, Dallas, TX (US)

(73) Assignee: Halid Ziya Yerebakan, Carmel, IN (US)

(21) Appl. No.: 18/062,640

(22) Filed: Dec. 7, 2022

(51) Int. Cl. G09B 5/04; G10L 15/12; G10L 15/22; G10L 25/18

(52) U.S. Cl. CPC G09B 5/04; G10L 15/12; G10L 15/22; G10L 25/18; G09B 5/06; G10L 2015/225

(57) ABSTRACT

Methods and systems for giving feedback to users about the correct pronunciation of phrases in the Quranic recitation are disclosed. The method comprises playing an exemplary pronunciation on a sound device and optionally displaying it on a display device and starting sound recording for a response automatically. The response gets analyzed after sound recording with an automated speech recognition system and a comparison mechanism. Then, the method advances to the next target phrase if the response is correct or repeats the same phrase if it is incorrect with predefined correctness criteria without any extra user interaction.

### PRIOR ART

This application has prior art in United States patent applications, the entire contents of all of which are incorporated herein by reference: U.S. patent application Ser. No. 12/165,258, “INTERACTIVE LANGUAGE PRONUNCIATION TEACHING”, filed Jun. 30, 2008,

Also, the prior art U.S. patent application Ser. No. 14/705,634 “PRONUNCIATION LEARNING FROM USER CORRECTION” filed May 6, 2015

TajweedMate Mobile Application, “https://www.tajweedmate.com”, accessed Aug. 28, 2022

Tarteel Quran Application, “https://www.tarteel.ai/”, accessed Aug. 28, 2022

### BACKGROUND OF THE INVENTION

The Quran is a religious text that has been revealed in Arabic. People around the world in Islam learning Quran's Arabic pronunciation in a well-structured way for more than a thousand years.

Learning to read The Quran requires frequent practice to master the pronunciation. Automated feedback with speech recognition has been demonstrated to be an invaluable tool for reducing the need for human evaluation.

However, they require frequent user interaction beyond speech itself. Users need to interact with the touch interface, select the lessons, and listen to the expected pronunciation. Thus, they often slow down the learning progress.

It is desirable to have a computer-implemented method for speech practice in continuous conversation (dialogue) mode without any interruptions during learning or without the need for an electronic display. Especially in driving or walking conditions, this would benefit the learning process significantly.

### SUMMARY OF THE INVENTION

This present invention provides a system to teach the correct pronunciation of the Quran from exemplary phrases that are defined in an expert-defined curriculum using automatic speech recognition without requiring any navigational user interaction except speech input.

An exemplary system comprised of playing the true pronunciation of the first selected phrase from a plurality of phrases and starting sound recording and applying an automated speech recognition algorithm to convert the first sound record into token probabilities. These token probabilities are then used to compare to the first selected phrase to check the correctness. This correctness could be used in the decision to advance to the next phrase in the learning curriculum.

An exemplary system may also include repetition of the true pronunciation of the first selected phrase until acceptance of each speech input. That feature would ensure learning of the phrase before advancing to the next one.

Optionally, a performance indicator for visual feedback or visual demonstrations of correct and wrong pronunciation parts in a text form could be shown automatically to demonstrate the quality of pronunciation such that progress could be monitored.

### BRIEF DESCRIPTION OF DRAWINGS

FIG. 1 illustrates the exemplary flow diagram of the exemplary system.

FIG. 2 illustrates an exemplary method for the quantification of correctness within the exemplary system.

### DETAILED DESCRIPTION OF THE INVENTION

The feedback loop is essential to learning any new skill. Learning the pronunciation of the Quran in the Arabic language is no different from this perspective. People learn the language by listening, imitating, and getting feedback. The method described herein automates the feedback loop of learning the pronunciation of the Quran with the help of speech recognition.

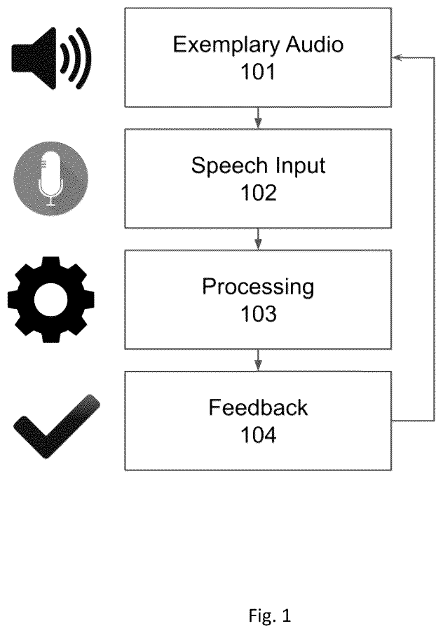

Referring to FIG. 1, step 101 indicates playing the first sound record of the true pronunciation of the first selected phrase from the predefined sound record database as an exemplary phrase for the practice. The sound record database consists of a plurality of digitally stored records of pronunciation examples indexed with the corresponding true written form. In this step, playing the correct pronunciation allows users to learn phrases while listening.

In step 102, the user tries to imitate the same sound from step 101. This step consisted of automatically activating the sound capture device after the playback of step 101, recording the utterance of the user, and deactivating it after the utterance.

The activation of the capture device could be further automated by predefined time intervals to automate to stop recording. For example, two times the length of the sound record for the original exemplary phrase.

In another alternative, silence detection could be used to stop recording automatically without the need to define record time duration.

In step 103, the recorded signal is analyzed using a speech recognition system.

Speech recognition systems consist of input signal processing, a machine learning method that transfers processed input signals to output probabilities in character/phoneme space.

Input signal processing could be but is not limited to taking Fast Fourier Transforms of the raw audio signal data, normalizing, or thresholding based on statistical values of raw signal data.

A machine learning method could be but is not limited to training a neural network with a prior automated speech recognition dataset consisting of pairs of sound records and corresponding written forms or using previously pre-trained automated speech recognition models for the selected language.

In step 104, the system quantifies the correctness of the output and gives output to decision control to either pass to the next exemplary phrase or repeat the current one.

Checking the correctness could be but is not limited to registering machine learning output to the expected written form of the first sound record or calculating the number of matches between the decoded result of the automated speech recognition system and the expected written form of the first sound record.

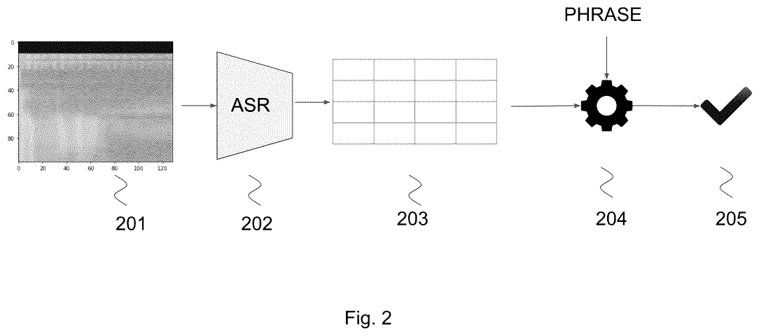

Referring to FIG. 2, the registration system is detailed as it gets the preprocessed input sound record and outputs the character probability matrix where entries are character likelihoods in each time point and registers it to the expected phrase.

In step 201, the system gets the preprocessed sound record input in the form of a matrix. In one dimension, it represents the time points. In the other dimension, it represents different frequencies that exist in the sound record.

In step 202, the system executes the pre-trained neural network and computes the output character/phoneme probabilities shown in step 203.

In step 204, the registration unit takes the expected output phrase and compares the neural network output to the expected phrase in the text form.

The simplest comparison method could use the output probabilities and get the highest probable character in each time point and compute the character list sequence. Correctness could be calculated by checking the exact match or ratio of the character matches of speech recognition output and expected output after removing the prespecified control character list.

In some examples, a more comprehensive registration-based method could be used to check correctness. In those examples, a dynamic programming-based module could be used to assign elements to corresponding probabilities in the output matrix. The dynamic programming algorithm maximizes the total global matching score constrained by the order given in the expected output sequence.

In some examples, a penalty score could be associated with missing terms in a display device that could show the missing terms.

In step 205, the registration results could be quantified into a numeric value between 0 and 1 or a percentage score. A decision threshold on calculated score value could determine the advancement into the next exemplary phrase or repeating the same phrase.

The invention claimed is:

1. Methods and systems to teach the correct pronunciation of the Quran by playing the first exemplary phrase from a curriculum of exemplary phrases, capturing the user's sound recording of the recitation of the exemplary phrase, and repeating the same exemplary phrase if the recitation is not successful or advancing to the next exemplary phrase if it is successful.

2. The system of claim 1 wherein the success criterion is determined by an automated speech recognition system and an automated scoring algorithm.

3. The system of claim 2 wherein the scoring system is based on coherence between speech recognition system output and expected output.

4. The system of claim 3 wherein the scoring system is the ratio of character matches of automated speech recognition system and expected output.

5. The system of claim 3 wherein the scoring system is a registration-based score wherein the score is based on the best scoring of pairwise matches between speech recognition output and expected output.

6. The system of claim 5 where the search for best pairwise matches is calculated by a dynamic programming algorithm.

7. The system of claim 2 wherein recording is automatically stopped by a predefined time period.

8. The system of claim 2 wherein recording is automatically stopped by silence detection from speech recognition.

9. The system of claim 2 where a display device is displaying the matching score and calculated score and correct, missing, or wrong characters.

10. A computer-implemented method where the first exemplary sound record is played in a playback device, automatically starting sound recording from a recording device, capturing the sound record as an imitation of the exemplary phrase, stopping the recording automatically using a time period or with silence signal, processing input signal into a suitable matrix/tensor form, applying a speech recognition engine to obtain output character probabilities in different time points, comparing the output probabilities with first expected output phrase, scoring the matches using registration algorithm, and advancing to the next exemplary phrase with threshold-based decision criterion or repeating the first exemplary sound record again.

11. The method of claim 8 is where a display device displays the calculated score and correct, missing, or wrong characters.

12. The method of claim 10 where preprocessing uses the Fast Fourier Transform to obtain a suitable tensor form.

13. The method of claim 10 where exemplary phrases are executed is selected according to a predefined curriculum.
